(19) United States
(12) Patent Application Publication
(10) Pub. No.: US 2024/0169233 A1
(43) Pub. Date: May 23, 2024

(54) UNIVERSAL RANDOMIZED BENCHMARKING

(71) Applicant: Alibaba (China) Co., Ltd., Hangzhou, Zhejiang (CN)

(72) Inventors: Dawei DING, San Diego, CA (US); Jianxin CHEN, Kirkland, WA (US); Jiachen Huang, San Mateo, CA (US)

(21) Appl. No.: 18/177,422

(22) Filed: Mar. 2, 2023

Related U.S. Application Data
(60) Provisional application No. 63/269,799, filed on Mar. 23, 2022.

(51) Int. Cl. G06N 10/20; G06N 10/70

(52) U.S. Cl. CPC G06N 10/20; G06N 10/70

(57) ABSTRACT

Systems and methods are disclosed for benchmarking a set of quantum gates using a universal randomized benchmarking (URB) framework. This framework supports benchmarking of gate sets that lack a group structure, enabling new benchmarking schemes beyond group-based and other existing schemes. Benchmarking a set of quantum gates according to the URB framework can include selecting a probability distribution, an implementation map, and a measurement map based on the set of quantum gates. When the probability distribution, implementation map, and measurement map possess certain properties, the probability of correctly measuring a final state, as a function of the length of a sequence of gates applied to the quantum system, can approximate an exponential decay. This exponential decay can be used to determine a benchmark average fidelity for the set of quantum gates.

### CROSS-REFERENCE TO RELATED APPLICATIONS

This application claims the benefit of U.S. Provisional Application No. 63/269,799, filed Mar. 23, 2022, and titled “RANDOMIZED BENCHMARKING BEYOND GROUPS”, which is incorporated herein by reference in its entirety.

### TECHNICAL FIELD

The present disclosure generally relates to quantum computing, and more particularly, to a benchmarking protocol capable of benchmarking quantum gates that lack a group structure.

### BACKGROUND

Quantum computing can address classically intractable computational problems. However, existing quantum computational devices are limited by various sources of error and imprecision. Benchmarking can be used to determine the fidelity of a set of gates implemented on a quantum computational device. Existing benchmarking frameworks may require that a set of gates being benchmarked form a group. This requirement can limit the applicability of existing benchmarking frameworks.

### SUMMARY

The disclosed systems and methods relate to benchmarking a set of quantum gates on a quantum system. Such benchmarking includes selecting a measurement map, implementation map, and probability distribution based on the gate set, such that the gate set, measurement map, implementation map, probability distribution, and an initial state form an (epsilon, delta, gamma)-good URB scheme for the quantum system.

The disclosed embodiments include a method for benchmarking a quantum system of dimension d. The method can include operations. The operations can include obtaining a gate set. The operations can include selecting a measurement map, an implementation map, and a probability distribution based on the gate set. The operations can include estimating a first success probability for a sequence length m. The estimation can include choosing m random elements of the gate set according to the probability distribution. The estimation can include sequentially applying, to an initial state on the quantum system and according to the implementation map, the implementation of each chosen random element. The estimation can include obtaining a binary result by performing a measurement according to the measurement map on the final state. The operations can include providing a quality factor based on estimated success probabilities for differing sequence lengths, the estimated success probabilities including the first success probability.

In some embodiments, the measurement map, implementation map, probability distribution, and initial state can be selected such that the gate set, measurement map, implementation map, probability distribution, and initial state forms an (epsilon, delta, gamma)-good URB scheme for the quantum system.

In some embodiments, a twirling map for the quantum system can be a gamma-approximate twirl for gamma less than a function of delta.

In some embodiments, the quality factor can be a base of an exponential curve fitted to the estimated success probabilities for the differing sequence lengths.

In some embodiments, the probability distribution can be non-uniform and the gate set can form a group.

In some embodiments, the measurement map can include an inverse gate and a final measurement, and the gate set does not form a group.

In some embodiments, the (epsilon, delta, gamma)-good URB scheme can be under the Frobenius norm and a twirling map for the quantum system can be a gamma-approximate twirl for gamma less than a function of delta and the dimension d.

In some embodiments, the operations can further include selecting a gauge transformation. The measurement map, implementation map, probability distribution, gauge transformation, and initial state can be selected such that the gate set, measurement map, implementation map, probability distribution, gauge transformation, and initial state forms an (epsilon, delta, kappa, gamma)-good URB scheme for the quantum system under the diamond norm or trace norm.

In some embodiments, the implementation map for the selected gate set can be selected to satisfy a gate-dependent replacement error model condition, a gate-independent replacement error model condition, or a unitary 2-design with a gate-independent error condition.

In some embodiments, the quality factor can be the average fidelity of the gate set.

It is to be understood that both the foregoing general description and the following detailed description are exemplary and explanatory only and are not restrictive of the disclosed embodiments, as claimed.

The disclosed embodiments further include systems configured to perform the disclosed methods, and non-transitory, computer-readable media containing instructions for performing the disclosed methods.

### BRIEF DESCRIPTION OF THE DRAWINGS

The accompanying drawings, which comprise a part of this specification, illustrate several embodiments and, together with the description, serve to explain the principles and features of the disclosed embodiments. In the drawings:

FIG. 1A depicts an exemplary randomized benchmarking trial, in accordance with disclosed embodiments.

FIG. 1B depicts an exemplary exponential fidelity curve obtained using randomized benchmarking trials, in accordance with disclosed embodiments.

FIG. 2 depicts a system for performing universal randomized benchmarking, in accordance with disclosed embodiments.

FIG. 3 depicts an exemplary method for performing universal randomized benchmarking, in accordance with disclosed embodiments.

### DETAILED DESCRIPTION

Reference will now be made in detail to exemplary embodiments, discussed with regards to the accompanying drawings. In some instances, the same reference numbers will be used throughout the drawings and the following description to refer to the same or like parts. Unless otherwise defined, technical or scientific terms have the meaning commonly understood by one of ordinary skill in the art. The disclosed embodiments are described in sufficient detail to enable those skilled in the art to practice the disclosed embodiments. It is to be understood that other embodiments may be utilized and that changes may be made without departing from the scope of the disclosed embodiments. Thus, the materials, methods, and examples are illustrative only and are not intended to be necessarily limiting.

Performance characterization is an important part of the development and validation of quantum computing devices. Performance characterization can be achieved through benchmarking of a quantum computing device, a set of gates on the quantum computing device, or a particular implementation of the set of gates on the quantum computing device. An efficient and reliable benchmarking scheme can enable comparison between different quantum computing devices (e.g., produced by different manufacturers) and can also provide useful feedback information that facilitates device calibration and error diagnosis. Accordingly, such benchmarking can support development of future hardware designs and of fault-tolerant quantum computing. One such benchmarking framework is randomized benchmarking (RB).

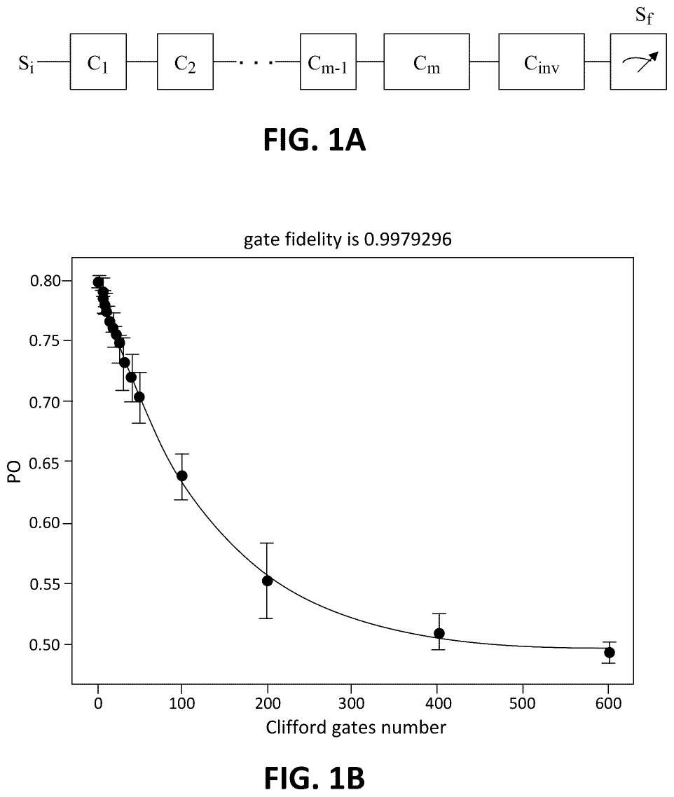

Conventional RB involves performing multiple benchmarking trials. As depicted in FIG. 1A, each benchmarking trial involves initializing a quantum system to a particular state (e.g., state Sᵢ) and applying to the quantum system a sequence of m gates (e.g., gates C₁ to Cₘ). These gates are selected from a mathematical group of quantum gates. The quantum system is initialized to a particular state (e.g., state Sᵢ). Because the quantum gates form a mathematical group, there exists an equivalent gate in the mathematical group that is equivalent to the entire sequence of gates. Similarly, there exists an inverse gate (e.g., Cᵢₙᵥ) that is the inverse of the equivalent gate. Applying the inverse gate after applying the sequence of m gates should ideally return the quantum system to the initial state. However, imperfect gate fidelity and errors in state preparation or measure can result in a final state (e.g., S_{f}) that differs from the initial state. Overall, these sources of error can be modeled as:

pₘ=A·u^{m}+B

where Pₘ is the probability of recovering the initial state (or more generally a success probability), A is the state preparation error, B is the measurement error, and the power uₘ is the gate fidelity error. In this model, the base u is an average gate fidelity and the exponent m is the number of applied gates in the sequence. Multiple benchmarking trials using sequences of m gates selected from the mathematical group can be used to estimate pₘ. Multiple sets of such benchmarking trials can be performed for different values of m. As depicted in FIG. 1B, an exponential curve can be fit to the experimentally obtained values of pₘ. This curve can be used to estimate the base u, which can serve as a fidelity benchmark of the quantum system. The fidelity benchmark may be transformed into a value ranging between zero and one.

Conventional RB exhibits technical problems that restrict the use of this benchmarking framework. Conventional RB can be limited to benchmarking groups of quantum gates, as most conventional RB frameworks require the existence of an inverse gate. However, some sets of quantum gates (e.g., virtual-Z gates) may not form a group and therefore cannot be tested using conventional RB. Furthermore, implementing a group structure may be technically difficult, as implementing a random n-qubit quantum gate in a group may require an impractical number of one or two-qubit quantum gates. For example, the average number of one- or two-qubit quantum gates required to implement a Haar-random n-qubit gate can increase exponentially with n. Similarly, the average number of one- or two-qubit quantum gates required to implement a Clifford n-qubit gate can increase as n². Consequently, neither of these groups can be used for conventional RB with current quantum system noise levels, as only a few quantum gates could be applied before the signal impermissibly decreased.

The disclosed embodiments provide a randomized benchmarking framework that addresses the limitations of conventional RB. As with conventional RB, this universal randomized benchmarking (URB) framework involves initializing a quantum system to an initial state, applying a sequence of m quantum gates to the quantum system, and performing a measurement. However, the URB framework does not require that the m quantum gates be selected from a group of quantum gates. Rather than applying a single inverse gate after applying a sequence of quantum gates selected from a group, a more general post-processing positive operator-valued measure (POVM) is performed after applying a sequence of quantum gates selected from a set (not necessarily a group). The chosen post-processing POVM depends on the quantum gates selected from the set and “verifies” that the gate sequence was correctly applied. Consistent with disclosed embodiments, the set of quantum gates, post-processing POVM, and probability distribution on the set of quantum gates can specify, at least in part, an implementation of the URB framework.

When an implementation of the URB framework satisfies certain assumptions disclosed herein, the results of URB trials will form an exponential decay curve with respect to the length of the random gate sequences. An average gate fidelity can then be determined in a manner similar to conventional RB. In particular, an exponential decay curve can be observed when a twirling map (a linear map on the set of quantum channels representing the averaged joint action of a random gate and its “inversion” in the post-processing POVM) is a γ-approximate twirl with γ<1. This result does not assume any underlying group structure, but instead involves the matrix perturbation theory of higher-order operators.

Consistent with disclosed embodiments, upper bounds for γ can be determined under various assumptions. These upper bounds can then be evaluated for a particular URB scheme to determine whether the twirling map is a γ-approximate twirl with γ<1. For example, such upper bounds exist when the probability measure used in sampling the gates is a convex combination of a unitary 2-design and another measure. Consistent with disclosed embodiments, the particular value of γ required to ensure single exponential decay can depend on the experimental error. The details of this dependence can involve the norm (e.g., the diamond norm, the trace norm, and the Frobenius norm, or the like) or gauge under which the twirling map is evaluated.

Furthermore, as disclosed herein, the physical meaning of the base value extracted using the URB framework can depend on the URB scheme. In general, when the “ideal twirl” (described herein) is a full twirl and when the noise channels add up to an replacement channel with the maximal eigenstate, the extracted base value can be associated with an average fidelity of the set of quantum gates under the sampling distribution. Such preconditions are satisfied, for example, under a gate-dependent replacement model or under certain gate independent noise models described herein.

In this manner, the disclosed embodiments enable a wider variety of URB benchmarking schemes that can address the shortcomings of conventional RB schemes, such as scalability. The disclosed embodiments therefore amount to a technological improvement in the benchmarking of quantum systems.

The spectrum of a Hermitian matrix is a vector in [symbol] . Norms of a Hermitian matrix can be defined using vector [symbol] p-norms of the spectrum of the Hermitian matrix. For general matrices, these are known as Schatten p-norms. These norms include:

The trace norm:

∥ρ∥₁:=∥spec(ρ)∥ [symbol] ₁=tr|ρ|.

The Frobenius norm:

∥ρ∥p:=∥spec(ρ)∥ [symbol] ₂=\sqrt{tr[ρ²]}.

The spectral norm:

$${‖ ρ ‖}_{∞} := {‖ spec ( ρ ) ‖}_{{ℓ}_{∞}} = {max}_{i} \vert {λ}_{i} ( ρ ) \vert ,$$

wherein:

∥ρ∥∞≤∥ρ∥p≤∥ρ∥₁≤\sqrt{d}·∥ρ∥p (EQ 1).

Quantum states are positive semidefinite operators with unit trace, and a positive operator-valued measurement (POVM) element is a positive semidefinite operator with spectral norm upper bounded by 1.

Define the Hilbert-Schmidt inner product on Hermitian matrices as [symbol] ·,· [symbol] _{HS}:(ρ,σ)→tr[ρσ]. Then the Frobenius norm of Hermitian matrices is induced by this inner product.

Linear maps C on Hermitian matrices are described herein as real superoperators. Real superoperators can be treated as linear maps. The following operator norms can be defined on the real superoperators.

The induced trace norm:

$${‖ C ‖}_{tr} := {max}_{ρ \neq 0} \frac{{‖ C ( ρ ) ‖}_{1}}{{‖ ρ ‖}_{1}} .$$

The induced Frobenius norm:

$${‖ C ‖}_{2} := {max}_{ρ \neq 0} \frac{{‖ C ( ρ ) ‖}_{F}}{{‖ ρ ‖}_{F}} .$$

The superoperator inner product norm:

$${〈 \cdot , \cdot 〉}_{SO} : ( C , D ) \to {\sum }_{i} {〈 C ( {X}_{i} ) , D ( {X}_{i} ) 〉}_{HS}$$

where {Xᵢ}ᵢ is an orthonormal basis of Hermitian matrices under the Hilbert-Schmidt inner product. Then a norm analogous to the Frobenius norm for matrices can be defined as:

∥C∥_{SO}:=\sqrt{ [symbol]C, C [symbol] .}

Another norm, called the diamond norm, can be defined on composite systems:

$${‖ C ‖}_{?} := {max}_{ρ \neq 0} \frac{{‖ ( C ⊗ id ) ( ρ ) ‖}_{1}}{{‖ ρ ‖}_{1}}$$

where id is the identity map on [symbol] .

The following relations hold from the definitions and equation 1:

∥ [symbol] ∥ₜᵣ≤∥ [symbol] ∥_{⋄},

\sqrt{d⁻¹}∥ [symbol] ∥₂≤∥ [symbol] ∥ₜᵣ≤\sqrt{d}∥ [symbol] ∥₂,

d⁻¹∥ [symbol] ∥₂≤∥ [symbol] ∥_{⋄}≤d∥ [symbol] ∥₂.

As does the following norm inequality:

$$\begin{matrix}{‖ 𝒞 ‖}_{S \leq O}^{2} = {\sum }_{i , j} {‖ 𝒞 ( E ( i , j ) ) ‖}_{2}^{2} \\ \leq {\sum }_{i , j} {‖ 𝒞 ( E ( i , j ) ) ‖}_{tr}^{2} \\ \leq {\sum }_{i , j} {max}_{{‖ ρ ‖}_{tr} = 1} {‖ 𝒞 ( ρ ) ‖}_{tr}^{2} \\ \leq {d}^{2} {‖ 𝒞 ‖}_{tr}^{2} ,\end{matrix}$$

where E(i,j)ₖₗ:=δᵢₖδⱼₗ are the elementary matrices, which are orthonormal under the Hilbert-Schmidt inner product and have unit trace norms. Therefore:

∥C∥_{SO}≤d∥C∥ₜᵣ

Likewise:

∥C∥ₜᵣ≤\sqrt{d}∥C∥₂≤\sqrt{d}∥C∥_{SO}

where the second inequality follows since any Hermitian matrix can be extended to a basis.

A quantum channel is a completely positive, trace-preserving (CPTP) map, and consequently has unit induced trace norm and unit diamond norm. Furthermore, a quantum channel has unit induced Frobenius norm if it is a unitary, and sub-unit induced Frobenius norm if it is a mixture of unitaries. The Hilbert space spanned by all channels equipped with the [symbol] ·,· [symbol] _{SO} inner product can be denoted V(d) . There exists a subspace V₀(d) with codimension 1 spanned by all differences in quantum channels. Taken together with an arbitrary quantum channel, this subspace spans the whole of V(d) . All norms defined on real superoperators naturally carry to V(d) and V₀(d). It can be verified that the above norms are all bona fide matrix norms, namely:

∥C+D∥≤∥C∥+∥D∥,∥C∘D∥≤∥C∥∥D∥

for arbitrary C and D. Furthermore, for the SO norm and the induced Frobenius norm:

∥C∘D∥_{SO}≤∥C∥₂∥D∥_{SO},∥C∥_{SO}∥D∥₂

Linear operators on real superoperators are denoted herein twirling maps. One can define the induced diamond norm of a twirling map Λ as:

$${\vert ‖ Λ ‖ \vert}_{?} := {max}_{C \neq 0} \frac{{‖ Λ ( C ) ‖}_{?}}{{‖ C ‖}_{?}}$$

The induced SO norm |∥·∥|₂:=∥·∥_{SO→SO} and induced trace norm |∥·∥|ₜᵣ:=∥·∥_{tr→tr} can be similarly defined. These induced norms are all matrix norms. For example, the |∥·∥|₂ norm corresponds to the usual spectral norm under the superoperator inner product. Under these definitions, the following property holds:

d^{-3/2}|∥Λ∥|₂≤|∥Λ∥|ₜᵣ≤d^{3/2}|∥Λ∥|₂

Additionally, if a twirling map A can be decomposed as:

Λ(·)=∫_{g}dgC(g)∘·∘D(g),

then

|∥Λ∥|≤∫_{g} dg∥C(g)∥∥D(g)∥,

Where the twirling map and real superoperator norms correspond. Moreover, a tighter bound exists regarding the induced SO norm on twirling maps and induced Frobenius norm on real superoperators:

|∥Λ∥|₂≤∫_{g} dg∥C(g)∥₂∥D(g)∥₂

Let II be a finite dimensional Hilbert space and V₁, V₂ be subspaces such that V₁⊕V₂=H. Let A₁ and A₂ be operators on V₁ and V₂ respectively. Let M(V₁, V₂) be the set of linear operators from V₁ to V₂, that is, linear operators P=X₁PX₂ where X₁ and X₂ are the projectors onto V₁ and V₂ respectively. For a norm defined on ∥·∥ defined on H, a corresponding separation function sep(·,·) can be defined:

$$sep ( {A}_{1} , {A}_{2} ) = {inf}_{P ∈ M ( {V}_{1} , {V}_{2} ) \backslash \{ 0 \}} \frac{‖ {A}_{1} P - {PA}_{2} ‖}{‖ P ‖}$$

Accordingly, given H, ∥·∥, V₁, V₂, X₁, and X₂. When A is linear operator on H such that

XᵢAXⱼ=Aᵢδᵢⱼ,i,jϵ{1,2}.

Let E be an arbitrary operator. If E satisfies

$$sep ( {A}_{1} , {A}_{2} ) - ‖ {X}_{1} {EX}_{1} ‖ - ‖ {X}_{2} {EX}_{2} ‖ > 0 , \\ \frac{‖ {X}_{2} {EX}_{1} ‖ ‖ {X}_{2} {EX}_{1} ‖}{sep ( {A}_{1} , {A}_{2} ) - ‖ {X}_{1} {EX}_{1} ‖ - ‖ {X}_{2} {EX}_{2} ‖} < \frac{1}{4} ,$$

Then there exist operators P₁, P₂ such that:

$${X}_{2} {P}_{1} {X}_{1} = {P}_{1} , {X}_{1} {P}_{2} {X}_{2} = {P}_{2} \\ ‖ {P}_{1} ‖ \leq \frac{2 ‖ {X}_{2} {EX}_{1} ‖}{sep ( {A}_{1} , {A}_{2} ) - ‖ {X}_{1} {EX}_{1} ‖ - ‖ {X}_{2} {EX}_{2} ‖} , \\ ‖ {P}_{2} ‖ \leq \frac{‖ {X}_{2} {EX}_{1} ‖}{sep ( {A}_{1} , {A}_{2} ) - ‖ {X}_{1} {EX}_{1} ‖ - ‖ {X}_{2} {EX}_{2} ‖ - 2 ‖ {P}_{1} ‖ ‖ {X}_{1} {EX}_{2} ‖} ,$$

Such that A+E can be diagonalized as

Lᵢ^{†}(A+E)Rⱼ=A′ᵢδᵢⱼ,

where:

$${[ {L}_{1} , {L}_{2} ]}^{†} = ( \begin{matrix}I & - {P}_{2} \\ 0 & I\end{matrix} ) {( \begin{matrix}I & 0 \\ - {P}_{1} & I\end{matrix} ) [ {X}_{1} , {X}_{2} ]}^{†} , \\ [ {R}_{1} , {R}_{2} ] = [ {X}_{1} , {X}_{2} ] ( \begin{matrix}I & 0 \\ {P}_{1} & I\end{matrix} ) ( \begin{matrix}I & {P}_{2} \\ 0 & I\end{matrix} ) \\ and \\ {A}_{1}^{′} = {A}_{1} + {X}_{1} {EX}_{1} + {X}_{1} {EP}_{1} , \\ {A}_{2}^{′} = {A}_{2} + {X}_{2} {EX}_{2} + {P}_{1} {EX}_{2} ,$$

Furthermore, given H and ∥·∥, the norm ∥·∥ induces a norm on linear operators. Let X₁, A, X₂=I−X₁ be linear operators on H such that: X₁ is an orthogonal projector, XᵢAXⱼ=Aᵢδᵢⱼ,i,jϵ{1,2}, μA₂∥=γ<1, ∥E∥≤δ, A₁=X₁, ∥X₁∥≤1, and

$$δ \leq \frac{1 - γ}{11} .$$

Then A+E can be diagonalized as given above with ∥P₁∥≤∥P₂∥≤1. Furthermore, all eigenvalues of A′₁ are 2δ-close to 1, ∥A₂∥≤(γ+6δ), and κ:=∥L₂∥∥R₂∥≤16 .

Give the set of qubit channels C(d) and the set of d×d Hermitian matrices H(d), then a universal randomized benchmarking (URB) scheme R on a d-dimensional quantum system can be expressed as a tuple (S, μ, ϕ, M, ρ₀) including:
A gate set S that includes the gates applied in the URB trials. The gate set S need not be a subset of the unitary group SU(d). Instead, S can encode any description that leads to an implementation of the gate independent of other gates in a circuit.
A probability distribution μ over the gate set S.
An implementation map ϕ:S→C(d) that maps from the set of gates to the physical gates applied to the quantum system. This implementation map can assume a gate-dependent noise model. The gate dependent noise model can be a Markovian noise model. The implementation map can alternatively assume a gate-independent noise model.
A post-processing POVM M:S^{*}→H(d) that maps from a finite string of elements of the gate set S to a Hermitian operator on [symbol] .
An initial state ρ₀ ∈H(d).

In accordance with a URB scheme R=(S, μ, ϕ, M, ρ₀), benchmarking of a quantum system can be performed as follows:
First, given sequence length m, m random elements g1, . . . , gm ∈S i.i.d. can be chosen according to the probability distribution μ.
Second, physical quantum gates implementing the sequence of m selected elements can be applied to the quantum system. The physical quantum gate(s) implementing each selected element can be determined according to the implementation map ϕ. For example, the sequence of physical gates can be ϕ(g₁), . . . , ϕ(gₘ) can be applied to the quantum system.
Third, a measurement M (g₁, . . . , gm) can be performed on the final state of the quantum system. In some embodiments, a binary result can be obtained. One of the binary values can indicate the success of the trial and the other can indicate the failure of the trial.
In step four, the first three steps can be repeated to obtain an estimate \hat{p}(m) of the success probability.
In step five, the first four steps can be repeated for differing length parameters m₁, . . . , mₖ to obtain corresponding success probability estimates \hat{p}(m₁), . . . , \hat{p}(mₖ). Each of the estimates \hat{p}(mᵢ) is an unbiased estimator of the quantity:

p_{R}(m):= [symbol] _{g}_{₁}_{, . . . , g}_{ₘ}_{˜μ}tr[M(g₁, . . . ,gₘ)·(ϕ(g₁)∘ . . . ∘ϕ(gₘ))ρ₀].

Consistent with disclosed embodiments, the output estimations \hat{p}(m₁), . . . , \hat{p}(mₖ) can be sufficiently close to the actual values p_{R}(m₁), . . . , p_{R}(mₖ) that these output estimations can be used to estimate the base of the power u^{m} in the error equation pₘ=A·u^{m}+B. However, such estimation may require that the output estimations exhibit a single exponential decay.

Consistent with disclosed embodiments, a URB scheme will exhibit a single exponential decay when the URB scheme is (ϵ, δ, δ)-good. A URB scheme is (ϵ, δ, γ)-good when the following conditions hold:

Approximate factoring of the post-processing POVM into a triple (M₀,99 ^{*},I), consistent with disclosed embodiments. There exists a final measurement M₀ ∈H(d), an inverting map ϕ^{*}:S→C(d) and an intermediate channel I ∈C(d) such that the post-processing POVM can be approximately factored into three parts:

$${sup}_{m ∈ M} {𝔼}_{{g}_{1} , … , {g}_{m} ∼ μ} {‖ M ( {g}_{1} , … , {g}_{m} ) - {M}_{0} \cdot {ϕ}^{*} ( {g}_{1} ) ∘ … ∘ {ϕ}^{*} ( {g}_{m} ) ∘ I ‖}_{∞} \leq ϵ ,$$

the notation for a Hermitian matrix p and superoperator C being:

ρ·C:=C^{†}(ρ),

where C^{†} is the adjoint superoperator with respect to the Hilbert-Schmidt norm (using · to denote scalar multiplication, matrix multiplication, or the above shorthand.)

There exists an ideal map ω:S→C(d) into unitary channels, such that the implementation map ϕ is close to the ideal map and the inverting map ϕ^{*} is close to its adjoint:

[symbol]

_{g˜μ}[∥ϕ(g)−ω(g) [symbol] +∥ϕ^{*}(g)−ω(g)^{†} [symbol] ]≤δ

The twirling map:

Λ_{R}^{*}: [symbol] →∫_{g∈μ}dgω^{†}(g)∘ [symbol] ∘ω(g)

is a γ-approximate twirl, such that:

|∥Λ^{*}_{R}−Λ^{*}∥|≤γ

under a certain norm |∥·∥| (e.g., the diamond norm, or another such norm) where:

Λ^{*}_{R}: [symbol] →∫_{g˜η}dgg^{†}∘ [symbol] ∘\tilde{g}

is the twirling map where ri is the Haar random distribution on SU(d), and \tilde{g}:ρ→gρg⁻¹ is the unitary channel corresponding to the fundamental representation of SU(d) for g. Consistent with disclosed embodiments, a URB scheme can be described as (ϵ, δ, γ)-good with respect to the factorization (M₀, ϕ^{*}, I) and the ideal map ω.

Let R be an (ϵ, δ, γ)-good URB scheme with respect to the diamond norm and assume that γ≤1−11δ. Then there exists A, B, p ∈ R, p ∈ [1−2δ, 1] such that:

|p_{R}(m)−(A+B·p^{m})|≤ϵ+16(γ+6δ)^{m}.

This bound can be tightened to p ∈ [1−δ, 1] using the Bauer-Fike theorem. Additionally, the above relation can be established under the assumption that the Hilbert space H is the channel space V(d) (e.g., as it is an invariant space under all twirling maps Λ^{*}, Λ^{*}_{R}, and Λ_{R}) or under the assumption that the Hilbert space H is the channel space channel difference space V₀(d) (e.g., as it is an invariant space under all twirling maps Λ^{*}, Λ^{*}_{R}, and Λ_{R} by taking as input the channel difference I−E_{ρ*}.). The ability to establish this relation under the assumption that the Hilbert space H is the channel space channel difference space can be used to give upper bounds on γ, as described herein.

In some embodiments, this result can require that γ<1, such that for sufficiently low experimental error δ, γ≤1−11δ. This result is more expansive than simply stating that there is a single exponential decay if the twirling map is close to the Haar twirl Λ(which intuitively means the unitary ensemble defined by μ,ω is close to a unitary 2-design). Instead, this result shows that γ need only be smaller than 1. This is not as strong of a requirement as being close to a unitary 2-design.

Consistent with disclosed embodiments, to extract a measured exponential decay from measured data, given sufficiently many repeated experiments, the magnitude of B should be significantly larger than 0, p should be significantly larger than γ+6δ, and ϵ should be sufficiently small.

Consistent with disclosed embodiments, the above result can be shown using twirling maps that map channels to channels. For an URB scheme R=(S, μ, ϕ,M, ρ₀), which is good with respect to factorization (M₀, ϕ^{*}, I) and the ideal map ω, an ideal twirling map:

Λ^{*}_{R}: [symbol] ∫_{g∈μ}dgω(g)^{†}∘ [symbol] ∘ω(g)

and the physical twirling map

Λ_{R}: [symbol] ∫_{g∈μ}dgϕ^{*}(g)∘ [symbol] ∘ϕ(g)

the validity measure p_{R}(m) can be approximated as a linear function of the m-th power of the physical twirling map Λ_{R}, transforming the problem into the study of the major spectral components of Λ_{R}. This transformed problem can be analyzed by regarding Λ_{R} as a perturbed version of the ideal twirling map Λ^{*}_{R}, whose spectral properties are given by the γ-approximation with respect to the Haar twirl Λ^{*}.

Consistent with disclosed embodiments, the ideal twirling map Λ^{*}_{R} can be a γ-approximate twirl with γ<1. A trivial upper bound to γ is 2, which follows directly from the ability to decompose the twirling map, as described above.

Given a probabilistic distribution μ on the set S together with the ideal map ω:S→SU(d) defines a probabilistic distribution on SU(d), from which the ideal twirling map Λ^{*}_{R} is uniquely determined. Consider probabilistic distributions μ on SU(d), and let:

Λ(μ):=∫_{g˜μ}ω(g)^{†}∘·∘ω(g)dg.

This formulation can be used to show bounds on γ for convex combinations and Pauli representations, as disclosed herein.

Consistent with disclosed embodiments, bounds on γ can be determined when ,u is a convex combination of a unitary 2-design v with any other measure. If μ is a p-convex combination of some measure μ′ and v, then:

Λ(μ)=∫(pμ′+(1−p)v)=pΛ(μ′)+(1−p)Λ(v)

This implies the set of twirling maps corresponding to some measure is convex, which in turn implies:

|∥Λ(μ)−Λ(v)∥|_{⋄}=|∥pΛ(μ′)+(1−p)Λ(v)−Λ(v)∥|_{⋄}≤p|∥Λ(μ′)∥|_{⋄}+p|∥Λ(v)∥|_{⋄}=2p

Moreover, Λ(v)=Λ(η), where η is the Haar random distribution on SU(d). Therefore, when μ is a p-convex combination of any measure and a unitary 2-design, μ is a 2p-approximate twirl.

Consider the Clifford group C(d)⊆SU(d) and let the measure μ_{c} be the uniform distribution over C(d). Suppose a discrete measure μ has support that includes C(d). Then it can be shown that μ is a 2(1−m|C(d)|)-approximate twirl. Therefore, when the support for a measure μ includes the Clifford group with all probabilities greater than half of that of the uniform distribution over the Clifford group, it is a γ-approximate twirl with γ<1.

Furthermore, consistent with disclosed embodiments, a (ϵ, δ, γ)-good URB scheme can be found over other distributions over the Clifford group. This result can be extended to any unitary 2-design that is a uniform distribution over a finite set.

Consistent with disclosed embodiments, this result can be extended to more general two-designs. Let v be a measure with support a finite subset S⊆SU(d) that is a unitary 2-design. Then it can be shown that when a measure μ has probability greater than half of the max probability of v on all of S, the measure μ is a γ-approximate twirl with γ<1. It can also be shown that the support of u need not be finite.

Consistent with disclosed embodiments, in quantum systems of qubits, the dimension of the quantum system d can depend on the number of qubits n (e.g., d=2ⁿ). Given the Pauli matrices {Pᵢ}ᵢ₌₁^{d}^{²} (e.g., tensor products of {I, X, Y, Z}) that span L( [symbol] ) and are orthogonal under the Hilbert-Schmidt inner product

tr[PᵢPⱼ]=dδᵢⱼ.

Consistent with disclosed embodiments, a linear operator can be expressed using this basis. Since superoperators can be expressed in terms of left and right multiplications by operators, a superoperator can be expressed as a matrix a whose coefficients are defined by:

$$𝒯 = {\sum }_{i , j} {α}_{i , j} {P}_{i} \cdot {P}_{j} .$$

The superoperator can then be denoted α( [symbol] ). The indices of the α matrix can range from 1 to d₂. Given a super-superoperator Λ, there exists a β tensor with coefficients

$$Λ : {P}_{i} \cdot {P}_{j} ↦ {\sum }_{k , l} {β}_{i , j}^{k , l} {P}_{k} \cdot {P}_{l} .$$

The β tensor can be linearly extended to obtain the action of Λ on any superoperator (e.g., twirling maps corresponding to a measure μ, or the like). The β tensor for Λ(μ) can be denoted β(μ). It can be shown that when β(μ) is the β tensor for the twirling map Λ(μ):

$${‖ \vert Λ ( μ ) - Λ ( η ) \vert ‖}_{◇} \leq \sqrt{{\sum }_{k , l , {k}^{′} , {l}^{′} = 1}^{{d}^{2}} \vert {\sum }_{i , j = 1}^{{d}^{2}} ( {β}_{i , j}^{k , l} ( μ ) - {β}_{i , j}^{k , l} ( η ) ) ( {β}_{i , j}^{{k}^{′} , {l}^{′}} ( μ ) - {β}_{i , j}^{{k}^{′} , {l}^{′}} ( η ) ) \vert} .$$

This is a direct and general upper bound on the diamond norm. Furthermore, when:

Λ(μ)=Λ(μ)∘Λ(μp),

where μₚ is the uniform distribution over Pauli operators, and [symbol] is a difference of two channels: [symbol] =N₁−N₂, then:

$${‖ [ Λ ( μ ) - Λ ( η ) ] ( 𝒯 ) ‖}_{◇} \leq {max}_{i ∈ [ {d}^{2} ]} {\sum }_{k , l = 1}^{{d}^{2}} \vert {β}_{i , i}^{k , l} ( μ ) - {β}_{i , i}^{k , l} ( η ) \vert {‖ 𝒯 ‖}_{∘}$$

where d²:={1, 2, . . . , d²}. Here, the Pauli representation permits the expression of a super-superoperator as a linear map on matrices, and the upper bound on the corresponding induced diamond norm resembles the induced trace norm for regular matrices:

$${‖ M ‖}_{1 \to 1} = {max}_{j} {\sum }_{i} \vert {M}_{i , j} \vert .$$

The assumption that Λ(μ) is right invariant under Λ(μₚ) supports a connection between the trace norm of the matrix α and the diamond norm of the superoperator. Consistent with disclosed embodiments, this assumption of right invariance can be implemented by adding a uniformly random Pauli operator before each random gate for any URB scheme, along with the fact that Λ(μₚ) is a projector. The restriction that [symbol] is a difference of channels enables the bounding of γ, as [symbol] is an invariant space under certain twirling maps and

V₀(d)={c·( [symbol] − [symbol] )|c∈ [symbol] , [symbol] ∈ [symbol] (d)}.

As a linear combination of a difference of channels is simply a scaled difference of channels. Without loss of generality, let c₁,c₂≥0 and consider

$${c}_{1} ( {𝒩}_{1} - {𝒩}_{2} ) + {c}_{2} ( {𝒩}_{3} - {𝒩}_{4} ) = ( {c}_{1} + {c}_{2} ) \cdot [ ( \frac{{c}_{1}}{{c}_{1} + {c}_{2}} {𝒩}_{1} + \frac{{c}_{2}}{{c}_{1} + {c}_{2}} {𝒩}_{3} ) - ( \frac{{c}_{1}}{{c}_{1} + {c}_{2}} {𝒩}_{2} + \frac{{c}_{2}}{{c}_{1} + {c}_{2}} {𝒩}_{4} ) ] .$$

where γ can be evaluated for μₚ:

$$\begin{matrix}{max}_{i ∈ [ {d}^{2} ]} {\sum }_{k , l = 1}^{{d}^{2}} \vert {β}_{i , i}^{k , l} ( μ ) - {β}_{i , i}^{k , l} ( η ) \vert = {max}_{i > 1} {\sum }_{k , l = 1}^{{d}^{2}} \vert {β}_{i , i}^{k , l} ( μ ) - {β}_{i , i}^{k , l} ( η ) \vert \\ = \vert 1 - \frac{1}{{d}^{2} - 1} \vert + ( {d}^{2} - 2 ) \cdot \vert 0 - \frac{1}{{d}^{2} - 1} \vert \\ = 2 \frac{{d}^{2} - 2}{{d}^{2} - 1} .\end{matrix}$$

For d=2, γ is already 4/3>1, so this result does not justify uniform Pauli randomized benchmarking. However, as d→∞, the upper bound goes to 2, which is the highest the induced diamond norm distance can be.

As described herein, when R is an (ϵ, δ, γ)-good URB scheme with respect to the diamond norm and γ≤1−11δ, a single exponential decay can be observed in success probability estimates \hat{p}(m) obtained experimentally according to the URB scheme R. However, upper bounds on the induced diamond norm can be difficult to compute, while other norms can be easier to compute or characterize.

Consistent with disclosed embodiments, single exponential decay can be established with respect to the trace norm. Let R=(S, μ, ϕ, M, ρ₀) be an (δ, δ, γ)-good URB scheme with respect to the tuple (M₀, ϕ^{*}, I, ω) under the trace norm. When

$$δ \leq \frac{1 - γ}{11} ,$$

there exists A, B ∈ [symbol] and p ∈ [1−2δ,1] (or p ∈ [1δ, 1]) such that:

|p_{R}(m)−(A+Bp^{m})|≤ϵ+16(γ+6δ)^{m}.

Whether single exponential decay can be established depends on whether γ<1 under the trace norm.

The diamond norm or trace norm of a given twirling map can be determined via semidefinite programming. In some instances, the spectrum of the twirling map can be determined instead through diagonalization of its matrix representation, which may be easier. The conditions on the existence of a single exponential decay can be expressed in terms of a spectral gap and an error term involving the dimension of the quantum system.

Consistent with disclosed embodiments, single exponential decay can be established with respect to the Frobenius norm. Let R=(S, μ, ϕ, M, ρ₀) be an (ϵ, δ, γ)-good URB scheme with respect to the tuple (M₀, ϕ^{*}, I, ω) under the ∥·∥₂ norm. Let δ′:=d·δ. Furthermore, when ϕ^{*} or ϕ maps to unitary mixtures, these bounds can further be restricted to δ′ :=\sqrt{d}·δ. When

$${δ}^{′} \leq \frac{1 - γ}{11} ,$$

there exists A, B ∈ [symbol] and p ∈ [1−2δ′, 1](or p ∈ [1−δ′,1]) such that:

|p_{R}(m)−(A+Bp^{m})|≤ϵ+16d^{3/2}(γ+6δ′)^{m}.

The differences between the bounds for the Frobenius norm and the bounds for the trace and diamond norm arise from the inequality relationships between these norms, as described above in the Notations section. Whether single exponential decay can be established depends on whether γ<1 under the Frobenius norm.

RB schemes are known to be gauge invariant: an implementation map ϕ only needs to be close to a conjugation of the ideal map ω in order to exhibit the desired exponential decay, even if ϕ and ω were far apart under diamond norm. This is still true in the URB setting and enables the following alternative definition for the near-ideal implementation.

Consistent with disclosed embodiments, a URB scheme R=(S, μ, ϕ, M, ρ₀) with ϵ approximate factoring of M into (M₀, ϕ^{*}, I) has a (δ, κ) near-ideal implementation when there exists an ideal map ω:S→C(d) and gauges U, V that are invertible real superoperators, such that

|∥ [symbol] ∥|_{⋄}|∥ [symbol] ∥|_{⋄}|∥ [symbol] ∥|_{⋄}|∥ [symbol] ∥|_{⋄}≤κ,

and

[symbol]

_{g˜μ}[∥ [symbol] ∘ϕ(g)∘ [symbol] −ω(g)∥_{⋄}+∥ [symbol] ∘ϕ^{*}(g)∘ [symbol] −ω^{†}(g)∥_{⋄}]≤δ.

Consistent with disclosed embodiments, a URB scheme R is (ϵ, δ, γ, κ)-good under gauge if it has such a near-ideal implementation. The gauge free version corresponds to the case that U=V=id and κ=1. The single exponential decay results for different norms can be readily applied to good URB schemes under gauge.

Consistent with disclosed embodiments, single exponential decay can be established under gauge using the diamond or trace norm. Let R=(S, μ, ϕ, M, ρ₀) be an (ϵ, δ, δ, κ)-good URB scheme with respect to the tuple (M₀, ϕ^{*}, I, ω, U, V) under the diamond norm or the trace norm. When

$$δ \leq \frac{1 - γ}{11}$$

there exists A, B ∈ [symbol] and p ∈[1−2δ,1] (or p ∈ [1−2δ,1] (or p ∈ [1−δ, 1]) such that:

|p_{R}(m)−(A+Bp^{m})|≤ϵ+16κ(γ+6δ)^{m}.

Consistent with disclosed embodiments, single exponential decay can be established under gauge using the Frobenius norm. Let R=(S, μ, ϕ, M, ρ₀) be an (ϵ, δ, γ, κ)-good URB scheme with respect to the tuple (M₀, ϕ^{*}, I, ω, U, V) under the Frobenius norm. Let δ′:=d·δ.

When

$${δ}^{′} \leq \frac{1 - γ}{11}$$

there exists A, B ∈ [symbol] and p ∈ [1−2δ,1]0 (or p ∈ [1−δ, 1]) such that:

|p_{R}(m)−(A+Bp^{m})|≤ϵ+16κd^{3/2}(γ+6δ′)^{m}.

Furthermore, when ϕ^{*} or ϕ maps to unitary mixtures, these bounds can further be restricted to δ′:=\sqrt{d}·δ.

Consistent with disclosed embodiments, the above result can be shown using, in place of the physical twirling map, a gauge-corrected twirling map:

\tilde{Λ}_{R}:=∫_{g˜μ}dg [symbol] ∘ϕ^{*}(g)∘ [symbol] ∘·∘ [symbol] ∘ϕ(g)∘ [symbol] ,

with the observation that

tr[M₀·Λ_{R}^{m}( [symbol] )(ρ₀)]=tr[M₀· [symbol] ∘\tilde{Λ}_{R}^{m}( [symbol] ∘I∘ [symbol] )∘ [symbol] (ρ₀)].

By treating \tilde{Λ}_{R} as a perturbed version of Λ^{*}_{R}, the diagonalization (L₁, L₂, R₁, R₂, A′₁, A′₂) of \tilde{Λ}_{R} can be obtained, yielding:

tr[M₀·Λ_{R}^{m}( [symbol] )(ρ₀)]

=tr[M₀· [symbol] ∘L₁(A′₁)^{m}R₁( [symbol] ∘ [symbol] ∘ [symbol] )∘ [symbol] (ρ₀)]+tr[M₀· [symbol] ∘L₂(A′₂)^{m}R₂( [symbol] ∘ [symbol] ∘ [symbol] )∘ [symbol] (ρ₀)].

The second term is bounded by an exponential decay:

tr[M₀ [symbol] ∘L₂(A′₂)^{m}R₂( [symbol] ∘ [symbol] ∘ [symbol] )∘ [symbol] (ρ₀)]

≤|∥ [symbol] ∘L₂(A′₂)^{m}R₂( [symbol] ∘ [symbol] ∘ [symbol] )∘ [symbol] ∥|_{⋄}

≤|∥ [symbol] ∥|_{⋄}·|∥ [symbol] ∥|_{⋄}·|∥L₂(A′₂)^{m}R₂∥|_{⋄}·|∥ [symbol] ∘ [symbol] ∘ [symbol] ∥|_{⋄}

≤κ·|∥L₂(A′₂)^{m}R₂∥|_{⋄},

While the first term is a single exponential decay.

The decay base in an RB or URB scheme can indicate the average “quality” of a collection of gate implementations. Mathematically, the decay base corresponds to the second largest eigenvalue (a real eigenvalue when the URB scheme is good) of the twirl operator Λ_{R}.

Here, the eigen-channel with eigenvalue 1 is always a replacement channel ε_{ρ}_{^{*}}. All other eigen-superoperators, including the one corresponding to the second largest eigenvalue, lie in the space of channel differences V₀(d). For example, any eigen-channel [symbol] ∈ C(d) of Λ_{R} must be of eigenvalue 1 (otherwise Λ_{R}( [symbol] ) is no longer a channel) and consequently corresponds to an eigen-superoperator [symbol] −ε_{ρ}_{^{*}} ∈ V₀(d). Let [symbol] _{R} ∈ V₀(d) be the eigen-superoperator corresponding to the eigenvalue p_{R}=λ₂.

Consistent with disclosed embodiments, a unitary gauge transformation can be performed when the line {ε_{ρ}_{^{*}}+λ· [symbol] _{R}|λ∈ [symbol] } contains a unitary channel [symbol] . A gauge transformation can generally be performed when the line {ε_{ρ}_{^{*}}+λ· [symbol] _{R}|λ∈ [symbol] } contains an invertible superoperator R. However, in this case the gauge transformation ϕ(g)→R∘ϕ(g)∘R⁻¹ may no longer prese. channels, hindering the interpretation of the decay base. When the line contains the unitary channel [symbol] , the unitary gauge transformation ϕ(g)→ [symbol] ∘ϕ(g)∘ [symbol] can ensure that the unitary channel is the identity channel id.

Λ_{R}(id)=p·id+(1−p)·εₚ_{^{*}}.

The exponent p is then related to the fidelity of the channel Λ_{R}(id)=∫_{g˜μ}dgϕ^{*}(g)ϕ(g), which in turn is the average fidelity of the channels ϕ^{*}(g)ϕ(g) under the probability distribution μ, specifically:

$${p}_{R} = \frac{d {𝔼}_{g ∼ μ} [ {F}_{avg} ( {ϕ}^{*} ( g ) ϕ ( g ) ) ] - 1}{d - 1} ,$$

where the average fidelity of a channel C is defined as

F_{avg}( [symbol] ):=∫_{U}dUF(U|0 [symbol] [symbol] 0|U^{†}, [symbol] (U|0 [symbol] [symbol] 0|U^{†}))

over Haar random unitaries U. One example of an error model satisfying this condition is the gate-dependent replacement model: that there exists probabilities p(g) and states p(g) for each g, such that:

ϕ^{*}(g)ϕ(g)=p(g)·id+(1−p(g))·ε_{p(g)},

∫_{g∈μ}dg(1−p(g))ρ(g)√ρ^{*}.

For gate-independent noise models:

ϕ^{*}(g)= [symbol] ∘ω^{†}(g)∘ [symbol] , ϕ(g)= [symbol] ∘ω(g)∘ [symbol] ,

either in-between noise models:

ϕ^{*}(g)=ω^{†}(g)∘ [symbol] _{L}, ϕ(g)= [symbol] _{R}∘ω(g)

or sandwiched noise models:

ϕ^{*}(g)= [symbol] _{L}∘ω^{†}(g), ϕ(g)=107 (g)∘ [symbol] _{R}

can be used through gauge transformation, where [symbol] _{L}:= [symbol] and [symbol] _{R}:=

[symbol]

For in-between noise models:

Λ_{R}(id)=Λ^{*}_{R}( [symbol] _{L}∘ [symbol] _{R})

In the case that μ gives rise to a unitary 2-design, or equivalently Λ^{*}_{R}=Λ^{*}

Λ_{R}(id)=Λ^{*}_{R}( [symbol] _{L}∘ [symbol] _{R})=p·id+(1−p)·dep,

where

$${p}_{R} = \frac{d \cdot {F}_{avg} ( {𝒩}_{L} ∘ {𝒩}_{R} ) - 1}{d - 1} .$$

This recovers the case that RB on unitary two-designs extracts the average fidelity of gate-independent noises.

For sandwiched noise models:

Λ_{R}(id)= [symbol] _{L}∘ [symbol] _{R}.

the RB base p_{R} relates to the average fidelity of [symbol] _{L}∘ [symbol] _{R} if the following holds:

∃p∈[0,1], [symbol] _{L}∘ [symbol] _{R}=p·id+(1−p)·ε_{ρ}_{^{*}},

where ρ^{*} is the eigenstate of the channel ∫_{g˜μ}dgϕ^{*}(g)=N_{L}∘∫_{g˜μ}dgω^{†}(g) . Satisfaction of this condition also ensures that p_{R}=p.

Accordingly, for gate-independent noise models, the RB base extracted from the experiment is not always determined by the average fidelity of the error channels, partially because the ideal twirl is not always a full twirl. Special cases in which the RB base is determined by the average fidelity of the error channels include when the ideal twirl is a full twirl and when the noise channels add up to a replacement channel with the maximal eigenstate.

Consistent with disclosed embodiments, a sufficiently small perturbation to an exponential decay curve will not significantly affect the extracted decay rate.

Given an exponential decay curve of the form C₁(m)=A₀α^{m}+B₀ and a second exponential decay curve of the form C₁(m)=A₁β^{m}+B₁, when there exists an ϵ«A₀α^{M}/2 such that |C₁(m)−C₀(m)|≤ϵ for all integers m≥M then the decay rates β and α must satisfy the relation:

$$\vert β - α \vert \leq 2 ϵ \frac{α + 1}{{A}_{0} {α}^{M} - 2 ϵ} .$$

If 1>β≥α>0, then

$$β ( {A}_{0} {α}^{M} - 2 ϵ ) \leq β {A}_{1} {β}^{M} = {A}_{1} {β}^{M + 1} \leq {A}_{0} {α}^{M + 1} + 2 ϵ \to β - α \leq \frac{{A}_{0} {α}^{M + 1} + 2 ϵ}{{A}_{0} {α}^{M} - 2 ϵ} - α = \frac{2 ϵα + 2 ϵ}{{A}_{0} {α}^{M} - 2 ϵ} .$$

Given that the fitted curve is O(ϵ/A₀)-close to a certain ground truth single exponential decay curve under the [symbol] -norm, the above results provide a bound on the deviation of the decay rate. Such [symbol] _{∞} deviations come from the error terms ϵ+16(γ+6δ)^{m}, standard deviation from sampling

$$Θ ( \frac{log k}{\sqrt{K}} ) ( k$$

being the number of sequence lengths chosen and K the number of repeats for each sequence length), and imperfect fitting algorithms. Even though finite ϵ makes the error term non-vanishing, unless the number of samples for each sequence length exceeds ϵ−2, the inaccuracy of base extraction mainly comes from stochastic fluctuations of the random experiments.

Consistent with disclosed embodiments, the post-processing POVM M is defined abstractly for generality in the URB framework. The following examples of benchmarking schemes can be expressed in the URB framework. Note that while a scheme can be expressed in the URB framework, the scheme need not have a single exponential decay (e.g., unless the scheme is (ϵ, δ, γ)-good, which requires additional assumptions).

Standard group-based RB can be formulated as an URB scheme, where the gate set is taken as a group [symbol] , with the distribution μ being the uniform distribution over the group. The post-processing POVM is then M(g1, . . . , gm)=M₀ϕ(g₁⁻¹, . . . , gₘ⁻¹) (e.g., applying a fixed measurement after physically applying the gate corresponding to the inverse of the product of the previous elements). This post-processing POVM admits a δ-approximate factoring into the triple (M₀,\tilde{ω}^{†},id) when the implementation map ϕ is δ-close to a representation \tilde{ω}:

[symbol]

_{g˜μ}∥ϕ(g)−\tilde{ω}(g) [symbol] ≤δ.

In some instance, the uniform distribution over the image of the ideal map can form a unitary 2-design, the twirling map can be an exact twirl, and a single exponential decay can occur whenever

$$δ < \frac{1}{11} .$$

Standard RB can be modified such that the random gates are drawn from non-uniform distributions over a group (e.g., when drawing gates according to a Haar distribution is too computationally costly). Such RB variants can be expressed in terms of the URB framework, which makes no assumptions regarding the distribution. Consistent with disclosed embodiments, URB schemes with an ideal reference map ω give rise to a distribution (which need not be a uniform distribution) on the special unitary group of corresponding dimension. Consistent with disclosed embodiments, the distribution need not be approximately uniform, inverse-symmetric, or possess a support containing the generators of the group. Instead, the twirling map resulting from the distribution must be gapped under a particular norm.

In a Linear Cross-entropy Benchmarking (Linear XEB) framework, a certain number of layers, typically shallow, of random circuits C1, . . . , Cm are applied to an initial state. A subsequent measurement then returns a bitstring x, whose ideal probability q(x) is numerically simulated on a classical computer. The protocol returns the value 2ⁿq(x)−1, where n is the number of qubits in the system.

Linear XEB can be expressed in the URB framework, consistent with disclosed embodiments, provided that the random shallow circuits are chosen i.i.d. from a distribution μ over a set S. The expected outcome of a Linear XEB benchmarking protocol can be expressed as:

F(m)= [symbol] _{C}_{₁}_{, . . . ,C}_{ₘ}_{˜μ} [symbol] _{x˜\tilde{q}}[2^{N}q(x)−1],

where the distributions q, \tilde{q} are defined as

q(x)=| [symbol] x|Cₘ . . . C₁|0 [symbol] |²,

\tilde{q}(x)=tr[Mₓ·ϕ(Cₘ)∘. . . ∘ϕ(C₁)(ρ₀)]

for some POVM {Mₓ}_{x∈{0,1}}_{ⁿ} and initial state ρ₀. By lifting the distributions as diagonal operators, the expected outcome can be expressed as:

F(m)=2ⁿ· [symbol] _{C}_{₁}_{, . . . ,C}_{ₘ}_{˜μ}tr[Q\tilde{Q}]−1

where:

$$Q = {\sum }_{x} q ( x ) \vert x 〉 〈 x \vert = 𝒟 ∘ {𝒞}_{m} ∘ ⋯ ∘ {𝒞}_{1} ( \vert 0 〉 〈 0 \vert ) , \\ \tilde{Q} = {\sum }_{x} \tilde{q} ( x ) \vert x 〉 〈 x \vert = \tilde{𝒟} ∘ ϕ ( {𝒞}_{m} ) ∘ ⋯ ∘ ϕ ( {𝒞}_{1} ) ( {ρ}_{0} ) ,$$

with D:ρ→Σₓ [symbol] x|ρ|x [symbol] ·|x [symbol] [symbol] x| and \tilde{D}:ρ→Σₓ tr[Mₓρ]·|x [symbol] [symbol] x| representing the ideal and physical measurement under the computational basis, and Cᵢ the ideal implementation of Cᵢ as a unitary channel. Given that Q=Q^{†}:

F(m)=2ⁿ· [symbol] tr[|0 [symbol] [symbol] 0|· [symbol] ∘ [symbol] ∘ [symbol] ∘ϕ( [symbol] )∘ . . . ∘ϕ( [symbol] )(ρ₀)]−1

The post-processing POVM, being the combination of the quantum measurement followed by classical simulation, can be exactly factored in terms of a tuple (|0 [symbol] [symbol] 0|,\tilde{ω}^{†},\tilde{D}) with a prefactor of 2ⁿ.

Linear XEB experiments suggest that F(m) can be fit into a single exponential decay A′+B′·p^{m} with A′≈0 and B′=O(1). Thus B=2⁻ⁿB′«1. This implies that the single exponential decay may not be observable unless the circuit depth approaches ω(n log(1−γ)) so that the error term is negligible compared to the actual single exponential decay.

Cycle benchmarking is a protocol for measuring the Pauli errors of Clifford gadgets in a large-scale quantum processor. Given an n-qubit Clifford gate g ∈ Cₙ, let k=ord(g):=min{k ∈ [symbol] |g^{k}=I}. Each random element is chosen uniformly from the set of n-qubit Pauli operators Pₘ^{⊗k}, and is implemented by:

ϕ((P₁, . . . , Pₖ)):=φ(P₁)∘φ(g)∘ . . . ∘φ(Pₖ)∘φ(g),

for some physical implementation φ defined on all Pauli gates and g. It can be proven that in the noiseless case such implementations result in a Pauli operator, and it is therefore sufficient to calculate and implement the final Pauli gate as the recovery gate. The post-processing POVM can be approximately factored given ϕ on the set of Pauli operators is close to ideal.

One distinct feature of the cycle benchmarking framework is that there is almost never a single exponential decay: the twirling map would be far from an approximate twirl since the distribution effectively defined on the set of Pauli channels. Instead, there is typically an exponential number of exponential decay components from a single experiment. Multiple experiments, typically with different measurements, are required in order to isolate the exponential decay components to give useful information about the Pauli error channels.

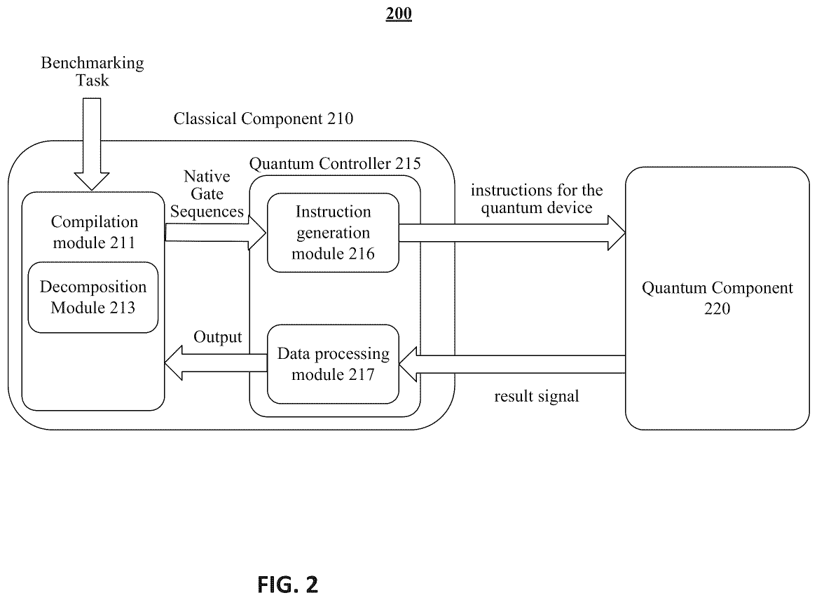

FIG. 2 depicts a system 200 for implementing a URB scheme, in accordance with disclosed embodiments. System 200 can include a classical component 210 (e.g., a classical computing device, or collection of classical computing devices) and a quantum component 220.

Quantum component 220 can be configured to process information using quantum phenomena (e.g., superposition or entanglement). Quantum component 220 can operate on units of information referred to as “qubits.” A qubit is the smallest unit of information in quantum computers, and can have any linear combination of two values, usually denoted |0 [symbol] and |1 [symbol] . The value of the qubit can be denoted |ψ). Different from a digital bit that can have a value of either “0” or “1,” |ψ) can have a value of α|0 [symbol] +β|1 [symbol] where α and β are complex numbers (referred to as “amplitudes”) not limited by any constraint except |α|²+|β|²=1. Quantum states of components of quantum component 220 can represent qubits. The disclosed embodiments are not limited to any particular qubit implementation. For example, a qubit can be physically implemented using photons (e.g., in lasers) with their polarizations as the quantum states, electrons or ions (e.g., trapped in an electromagnetic field) with their spins as the quantum states, Josephson junctions (e.g., in a superconducting quantum system) with their charges, current fluxes, or phases as the quantum states, quantum dots (e.g., in semiconductor structures) with their dot spin as the quantum states, topological quantum systems, or any other system that can provide two or more quantum states. Quantum component 220 can apply quantum logic gates (or simply “quantum gates”) to create, remove, or modify qubits.

In contrast, classical component 210 can be a computing system that cannot perform quantum computations, such as an electronic computer (e.g., a laptop, desktop, cluster, cloud computing platform, or the like). Classical component 210 can operate in digital logic on binary-valued bits. Classical component 210 can include one or more processors (e.g., CPUs, GPUs, or the like), application specific integrated circuits, hardware accelerators, or other components for processing digital logic. Classical component 210 can include one or more memories, buffers, caches, or other components for storing binary values. Classical component 210 can include one or more I/O devices for communicating with other systems, devices (e.g., quantum component 220), users, or the like.

The classical component 210 can be configured to control the quantum component 220. The classical component can include a compilation module 211. Compilation module 211 can be configured to obtain a description of a benchmarking task (e.g., a URB benchmarking task of quantum component 220). The description of the benchmarking task can include a description of the set of gates for use in benchmarking. As described herein, this set of gates may or may not form a group. In some embodiments, the description of the benchmarking task can include a probability distribution over the set of gates used for benchmarking task.

Based on the description of the benchmarking task, compilation module 211 can determine gate sequences for URB benchmarking. In some embodiments, compilation module 211 can determine sets of gate sequences for different sequence lengths m. Compilation module 211 can use the probability distribution in determining the sets of gate sequences. For example, compilation module 211 can sample from the set of gates according to the probability distribution to generate the sets of gate sequences.

As may be appreciated, quantum component 220 can be designed to implement the quantum gates using a set of native gates. Gate decomposition module 213 (which may be implemented as a submodule of compilation module 211) can be configured to decompose the gate sequences determined by compilation module 211 into sequences of native gates that can be physically implemented on quantum component 220. The sequences of native gates can then be provided to quantum controller 215.

Quantum controller 215 can be configured to directly control quantum component 220. Quantum controller 215 can be a digital computing device (e.g., a computing device including a central processing unit, graphical processing unit, application specific integrated circuit, field-programmable gate array, or other suitable processor). Quantum controller 215 can configure quantum component 220 for computation, provide quantum gates to, and read state information out of quantum component 220.

Quantum controller 215 can include an instruction generation module 216. The capabilities of instruction generation module 216 can depend on the particular implementation of quantum component 220. In some embodiments, instruction generation module 216 can be configured to directly or indirectly provide bias drives to quantum component 220 to enable or disable interactions between qubits. Instruction generation module 216 can indirectly provide bias drives by providing instructions to a bias drive source (e.g., waveform generator or the like), causing the bias drive source to provide the bias drives to quantum component 220. Instruction generation module 216 can apply native quantum gates by providing one or more microwave pulses (or other gate drives) to qubits in quantum component 220. In various embodiments, instruction generation module 216 can implement such gates by providing instructions to a computation drive source (e.g., a waveform generator or the like), causing the computational drive source to provide such microwave pulses (or other gate drives) to qubits in quantum component 220. The microwave pulses can be selected or configured to implement one or more native quantum gates, as described herein. The microwave pulses can be provided to qubits using one or more coils coupled to the corresponding qubits. The coils can be external to quantum component 220 or on a chip implementing quantum component 220.

Quantum controller 215 can be configured to determine state information for quantum component 220. In some embodiments, quantum controller 215 can measure a state of one or more qubits of quantum component 220. The state can be measured upon completion of a sequence of one or more quantum operations. In some embodiments, instruction generation module 216 can provide a probe signal (e.g., a microwave probe tone) to a coupled resonator of quantum component 220, or provide instructions to a readout device (e.g., an arbitrary waveform generator) that provides the probe signal. As may be appreciated, other measurement implementations are possible and the disclosed embodiments are not limited to such an implementation.

In various embodiments, quantum controller 215 can include a data processing module 217. The capabilities of data processing module 217 can depend on the particular implementation of quantum component 220. In some embodiments, data processing module 217 can take the output signal (e.g., electrical/ photonic), transform it into discrete signals, and perform data processing on it (e.g., averaging, post-processing) to obtain a computational result. In some embodiments, data processing module 217 can include, or be configured to receive information from, a detector configured to determine an amplitude and phase of an output signal received from the coupled resonator in response to provision of the microwave probe tone. The amplitude and phase of the output signal can be used to determine the state of the probed qubit(s). As may be appreciated, other measurement implementations are possible and the disclosed embodiments are not limited to such an implementation.

Consistent with disclosed embodiments, quantum controller 215 can be configured to provide output to compilation module 211 (or another suitable module of classical component 210).

Consistent with disclosed embodiments, classical component 210 (e.g., compilation module 211 or another suitable module of classical component 210) or another system, can be configured to use the output in determining a fidelity benchmark for quantum component 220.

In some embodiments, classical component 210 can be configured to determine whether the output indicated that the trial was successful. For example, the output can indicate that the measured final state of quantum component 220 matched an initial state of quantum component 220. Alternatively, the output can indicate that the measured final state of quantum component 220 matched the classically predicted final state of quantum component 220, given the initial state of quantum component 220 and the applied sequence of gates.

Consistent with disclosed embodiments, classical component 210 can be configured to estimate an expected success probability for sequences of length m, based on a success probabilities obtained from multiple trials. Classical component 210 can be further configured to determine a fidelity value based on average success probabilities for differing sequence lengths.

Consistent with disclosed embodiments, when classical component 210 determines the fidelity benchmark for quantum component 220, classical component 210 can be configured to provide that fidelity benchmark to a user (e.g., using a graphical user interface, or the like), to another system, or to a storage location accessible to classical component 210.

Quantum component 220 can be configured to receive commands (e.g., bias drives, quantum gates, probe signal, or the like) from the classical component 210. In some embodiments, quantum component 220 can be implemented using a superconducting quantum circuit coupled to quantum controller 215 using at least one microwave drive line. The superconducting quantum circuit can implement multiple qubits (e.g., transmon qubits, fluxonium qubits, or any other suitable type of qubit), consistent with disclosed embodiments. In some embodiments, the superconducting quantum circuit can be realized using one or more chips containing the qubits, each of the chip(s) including at least a portion of the microwave drive line(s) coupling the qubit(s) to quantum controller 215.

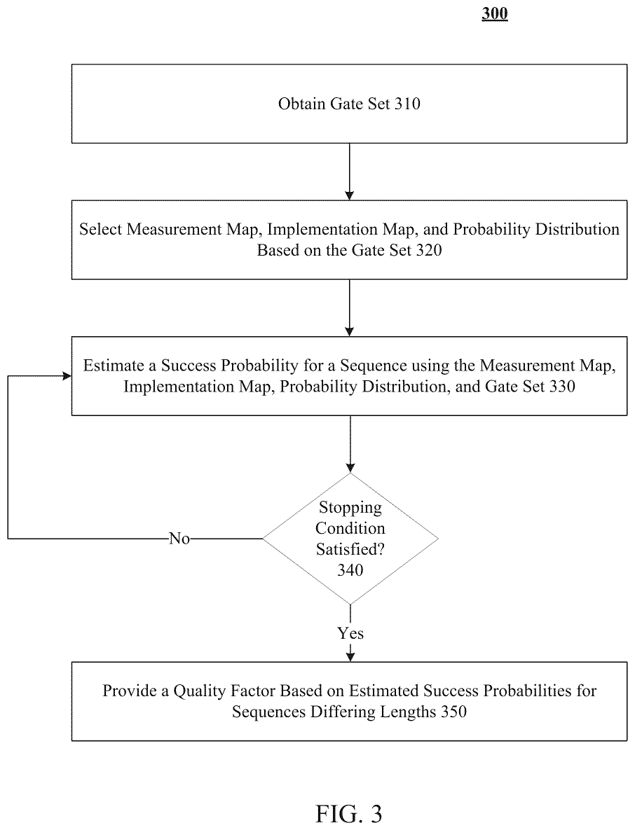

FIG. 3 depicts an exemplary method 300 for determining and implementing a URB scheme, in accordance with disclosed embodiments. In some embodiments, method 300 can be performed using system 200. Method 300 can include operations performed on a conventional computing device (e.g., a mobile device, laptop, desktop, workstation, computing cluster, cloud-computing platform, or the like) such as classical component 210. Method 300 can include operations performed on a quantum computing device (e.g., a quantum controller managing a superconducting circuit, trapped ion quantum systems, topological quantum computing systems, photonic quantum computing systems, or the like) such as quantum component 220.

Consistent with disclosed embodiments, the conventional computing device can be configured to apply gate sequences to the quantum computing device. The conventional computing device can also be configured to measure the state of the quantum computing device following application of each gate sequence. In some embodiments, the conventional computing device can be configured to estimate a success probability of obtaining the initial state (or a predicted state) of the quantum system. The initial state can be the state of the quantum system prior to application of the gate sequence. The predicted state can be a predicted (e.g., classically predicted) state of the quantum computing device, given the initial state of the quantum computing device and the applied gate sequence. In some embodiments, the success probability can be estimated using success measurements for gate sequences of length m. In some embodiments, the conventional computing device can be configured to determine a fidelity benchmark based on estimated success probabilities for gate sequences of multiple lengths.

In step 310 of method 300, the conventional computing device can obtain a set of gates, consistent with disclosed embodiments. The set of gates need not form a group. In some embodiments, the conventional computing device can be configured to select the set of gates. In some embodiments, the conventional computing device can be configured with a predetermined set of gates. In various embodiments, the conventional computing device can receive or retrieve an indication of the set of gates (e.g., from another system or through interactions with a user).

In step 320, the conventional computing device can obtain a measurement map, implementation map, and probability distribution. As described herein, the implementation map can map from the set of gates to the physical gates applied to the quantum system. This implementation map can assume a gate-dependent noise model. The gate dependent noise model can be a Markovian noise model. Alternatively, the implementation map can assume a gate-independent noise model. In some embodiments, the implementation map can depend on the quantum system. For example, the particular native gates used to implement each gate in the set of gates can depend on the particular realization of the quantum system.

Consistent with disclosed embodiments, the measurement map can be a post-processing POVM that maps from the sequence of applied gates to a Hermitian operator, as described herein. Consistent with disclosed embodiments, the probability distribution can describe the sampling frequency over the set of gates.

In some embodiments, the conventional computing device can receive or retrieve the measurement map, implementation map, or probability distribution from another system, or through an interaction with one or more users. For example, the conventional computing device can provide a user interface that enables a user to specify one or more of the measurement map, implementation map, probability distribution, or initial state of the quantum system. The user can then select one or more of these parameters based on the gate set. For example, given the gate set and the implementation map, the user can specify one or more of the measurement map or the probability distribution.

In some embodiments, the conventional computing device can automatically determine one or more of the measurement map, implementation map, probability distribution, or initial state. In some embodiments, the conventional computing device can select one or more of these parameters based on the gate set. For example, given the gate set and the implementation map, the conventional computing device can determine one or more of the measurement map or the probability distribution.

Consistent with disclosed embodiments, the user or the conventional computing device can specify or determine such parameters to ensure that the resulting URB scheme has desired properties. For example, the measurement map, implementation map, and probability distribution can be specified or determined such that, together with the initial state and the gate set, they form an (epsilon, delta, gamma)-good URB scheme for the quantum system.

Consistent with disclosed embodiments, selecting a measurement map can include selecting a measurement map that can be approximately factored into a final measurement, inverting map, and intermediate channel. Selecting the measurement map (or the implementation map) can include identifying an ideal map such that the inverting map is close to the adjoint of the ideal map, and the implementation map is close to the idea map.

In some embodiments, the measurement map, implementation map, and probability distribution can be selected such that the success probability of the URB scheme exhibits a single exponential decay. As described herein, such a selection can depend on an experimental error δ (e.g., known or estimated) or a choice of norm or gauge.

Consistent with disclosed embodiments, the parameters can be selected such that the URB scheme comprises a (ϵ, δ, γ)-good URB scheme with respect to the diamond norm or trace norm, with γ≤1−11δ.

Consistent with disclosed embodiments, the parameters can be selected such that the URB scheme comprises a (ϵ, δ, γ)- good URB scheme with respect to the Frobenius norm. A scaled experimental error δ′:=d·δ can be determined (or δ′:=\sqrt{d}·δ, when the implementation map or its adjoint are unitary mixtures), where d is the dimension of the quantum system, with γ≤1−11δ.

Consistent with disclosed embodiments, the parameters can be selected such that the URB scheme comprises a (ϵ, δ, γ, κ)-good URB scheme under gauge, for any of the diamond, trace, or Frobenius norms. Selection of the parameters can include selection of the ideal map and gauges U, V. Gauges U, V can be invertible real superoperators, such that

|∥ [symbol] ∥|_{⋄}|∥ [symbol] ∥|_{⋄}|∥ [symbol] ∥|_{⋄}|∥ [symbol] ∥|_{⋄}≤κ,

and

[symbol]

_{g˜μ}[∥ [symbol] ∘ϕ(g)∘ [symbol] −ω(g)∥_{⋄}+∥ [symbol] ∘ϕ^{*}(g)∘ [symbol] −ω^{†}(g)∥_{⋄}]≤δ.

Depending on the choice of norm, the parameters can be selected such that γ is less than 11δ (e.g., under the diamond or trace norm) or less than 11δ′ (under the Frobenius norm).

Consistent with disclosed embodiments, γ can be appropriately bounded through the selection of the probability distribution μ. For example, μ can be selected to be a p-convex combination of another measure and a unitary 2-design. The support for μ can include the Clifford group with all probabilities greater than half of that of the uniform distribution over the Clifford group. Then γ can be a γ-approximate twirl with γ<1. As an additional example, μ can be selected to have probability greater than half of the max probability on all of S of the unitary 2-design v with finite support S. In such a case, the support of μ need not be finite.

Consistent with disclosed embodiments, the scope of randomized benchmarking can be expanded using various combinations of the URB parameters. For example, the gate set may form a group, but the probability distribution may be selected to be non-uniform, while ensuring that γ remains appropriately bounded. As an additional example, the measurement map can comprise an inverse gate and a final measurement, but the gate set may not form a group.

Consistent with disclosed embodiments, the implementation map for the selected gate set can be selected to satisfy a gate-dependent replacement error model condition. In some embodiments, this model condition can be satisfied when there exists appropriate probabilities p(g) and states p(g) for each g, as described herein. Consistent with disclosed embodiments, the implementation map for the selected gate set can be selected to satisfy a gate-independent replacement error model condition. In some embodiments, this model condition can be satisfied when:

∃p∈[0,1], [symbol] _{L}∘ [symbol] _{R}=p·id+(1−p)·ε_{ρ}_{^{*}},

where ρ^{*} is the eigenstate of the channel ∫_{g˜μ}dgϕ^{*}(g)=N_{L}∘∫_{g˜μ}dgω^{†}(g) . Consistent with disclosed embodiments, the implementation map for the selected gate set can be selected to satisfy a unitary 2-design with a gate-independent error condition. In some embodiments, this model can be satisfied when Λ^{*}_{R}=Λ^{*} and

Λ_{R}(id)=Λ^{*}_{R}( [symbol] _{L}∘ [symbol] _{R})=p·id+(1−p)·dep,

where

$${p}_{R} = \frac{d \cdot {F}_{avg} ( {𝒩}_{L} ∘ {𝒩}_{R} ) - 1}{d - 1} .$$

In each of these conditions, the base obtained from the fit to the experimental data can be interpreted as being the average fidelity of the channels ϕ^{*}(g)ϕ(g) under the probability distribution μ.

In step 330, the conventional computing device can estimate a success probability for sequences of gates of a particular sequence length, consistent with disclosed embodiments. The success probability can be estimated through repeated trials. In each trial, the conventional computing device can initialize the quantum computing device to the selected initial state. The conventional computing device can generate a sequence of gates by selecting gates from the gate set according to the probability distribution. The conventional computing device can transform the sequence of gates into suitable native gates according to the implementation map and apply them to the quantum system. The conventional computing device can then generate an output by measuring the final state of the quantum system according to the measurement map.

The disclosed embodiments are not limited to any particular criterion for determining the number of trials used in estimating the success probability for the sequence length. In some embodiments, the criterion can depend on time, a predetermined number of trials conducted, or any combination of the foregoing. In some embodiments, the predetermined number of trials can be selected to satisfy a statistical criterion (e.g., a standard deviation, confidence interval, interval estimate, standard error of the mean, or other statistical value).

In step 340, the conventional computing device can determine whether a stopping condition is satisfied. If the stopping condition is not satisfied, method 300 can return to step 310 and a success probability for sequences of gates of another sequence length can be estimated, consistent with disclosed embodiments. Such estimation can include conducting repeated trials using gate sequences of this other sequence length. If the stopping condition is satisfied, method 300 can proceed to step 350.

The stopping condition can depend on time, a number of success probabilities estimated, a statistical criterion, or any combination of the foregoing. For example, the conventional computing device can determine that the stopping condition is satisfied when an elapsed benchmarking time exceeds a predetermined time threshold. As an additional example, the conventional computing device can determine that the stopping condition is satisfied upon determination of success probabilities for a threshold number of sequence lengths. In some embodiments, the conventional computing device can determine that the stopping condition is satisfied based on a goodness of fit, residual error, or the like for an exponential curve fit to the threshold number of sequence lengths.

In step 350, the computing device can be configured to determine a quality factor, in accordance with disclosed embodiments. The quality factor can depend on success probabilities estimated in step 330. In some embodiments, the quality factor can be a base of an exponential curve fit to the estimated success probabilities. For example, the fitted curve can have the formula:

\hat{p}ₘ=A·u^{m}+B

where \hat{p}ₘ is the estimated success probability for the sequence of length m, and u is the quality factor. The quality factor can generally be treated as a figure of merit for the quantum system. Furthermore, as described herein, under gate-dependent or certain gate independent noise models, the quality factor can be interpreted as an average fidelity of the gate set under the probability distribution.

The disclosed embodiments are not limited to embodiments in which a single conventional computing device obtains the gate set; selects the measurement map, the implementation map, the probability distribution, and the initial state; estimates the success probabilities, and provides the quality factor. In various embodiments, these operations can be performed by multiple computing devices. For example, a first conventional computing device can obtain the gate set and select the measurement map, the implementation map, the probability distribution, and the initial state. A second conventional computing device can determine the gate sequences for the trials and calculate the quality factor. And a third conventional computing device can apply the sequence of quantum gates to the quantum computing device and obtain the outcome measure.

In some embodiments, a non-transitory computer-readable storage medium including instructions is also provided, and the instructions may be executed by a device for performing the above-described methods, such as the method of FIG. 3. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM or any other flash memory, NVRAM, a cache, a register, any other memory chip or cartridge, and networked versions of the same. The device may include one or more processors (CPUs), an input/output interface, a network interface, or a memory.

The foregoing descriptions have been presented for the purposes of illustration. They are not exhaustive and are not limited to precise forms or embodiments disclosed. Modifications and adaptations of the embodiments will be apparent from consideration of the specification and practice of the disclosed embodiments. For example, the described implementations include hardware, but systems and methods consistent with the present disclosure can be implemented with hardware and software. In addition, while certain components have been described as being coupled to one another, such components may be integrated with one another or distributed in any suitable fashion.

Moreover, while illustrative embodiments have been described herein, the scope includes any and all embodiments having equivalent gates, modifications, omissions, combinations (e.g., of aspects across various embodiments), adaptations or alterations based on the present disclosure. The gates in the claims are to be interpreted broadly based on the language employed in the claims and not limited to examples described in the present specification or during the prosecution of the application, which examples are to be construed as nonexclusive. Further, the steps of the disclosed methods can be modified in any manner, including reordering steps or inserting or deleting steps.

It should be noted that, the relational terms herein such as “first” and “second” are used only to differentiate an entity or operation from another entity or operation, and do not require or imply any actual relationship or sequence between these entities or operations. Moreover, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items.

The features and advantages of the disclosure are apparent from the detailed specification, and thus, it is intended that the appended claims cover all systems and methods falling within the true spirit and scope of the disclosure. As used herein, the indefinite articles “a” and “an” mean “one or more.” Further, since numerous modifications and variations will readily occur from studying the present disclosure, it is not desired to limit the disclosure to the exact construction and operation illustrated and described, and accordingly, all suitable modifications and equivalents may be resorted to, falling within the scope of the disclosure.

As used herein, unless specifically stated otherwise, the term “or” encompasses all possible combinations, except where infeasible. For example, if it is stated that a database may include A or B, then, unless specifically stated otherwise or infeasible, the database may include A, or B, or A and B. As a second example, if it is stated that a database may include A, B, or C, then, unless specifically stated otherwise or infeasible, the database may include A, or B, or C, or A and B, or A and C, or B and C, or A and B and C.

It is appreciated that the above-described embodiments can be implemented by hardware, or software (program codes), or a combination of hardware and software. If implemented by software, it may be stored in the above-described computer-readable media. The software, when executed by the processor, can perform the disclosed methods. The computing units and other functional units described in this disclosure can be implemented by hardware, or software, or a combination of hardware and software. One of ordinary skill in the art will also understand that multiple ones of the above-described modules/units may be combined as one module/unit, and each of the above-described modules/units may be further divided into a plurality of sub-modules/sub-units.

In the foregoing specification, embodiments have been described with reference to numerous specific details that can vary from implementation to implementation. Certain adaptations and modifications of the described embodiments can be made. Other embodiments can be apparent to those skilled in the art from consideration of the specification and practice of the invention disclosed herein. It is intended that the specification and examples be considered as exemplary only, with a true scope and spirit of the invention being indicated by the following claims. It is also intended that the sequence of steps shown in figures are only for illustrative purposes and are not intended to be limited to any particular sequence of steps. As such, those skilled in the art can appreciate that these steps can be performed in a different order while implementing the same method.

In the drawings and specifications, there have been disclosed exemplary embodiments. However, many variations and modifications can be made to these embodiments. Accordingly, although specific terms are employed, they are used in a generic and descriptive sense only and not for purposes of limitation or restriction of the scope of the embodiments, the scope being defined by the following claims.

What is claimed is:

1. A method for benchmarking a quantum system of dimension d, comprising:
obtain a gate set;
select a measurement map, an implementation map, and a probability distribution based on the gate set;
estimate a first success probability for a sequence length m, estimation including:
choose m random elements of the gate set according to the probability distribution,
sequentially apply, to an initial state on the quantum system and according to the implementation map, the implementation of each chosen random element, and
obtain a binary result by perform a measurement according to the measurement map on the final state; and
provide a quality factor based on estimated success probabilities for differing sequence lengths, the estimated success probabilities including the first success probability.

2. The method of claim 1, wherein:
the measurement map, implementation map, probability distribution, and initial state are selected such that the gate set, measurement map, implementation map, probability distribution, and initial state forms an (epsilon, delta, gamma)-good URB scheme for the quantum system.

3. The method of claim 2, wherein:
a twirling map for the quantum system is a gamma-approximate twirl for gamma less than a function of delta.

4. The method of claim 2, wherein:
wherein the quality factor is a base of an exponential curve fitted to the estimated success probabilities for the differing sequence lengths.

5. The method of claim 2, wherein:
the probability distribution is non-uniform and the gate set forms a group.

6. The method of claim 2, wherein:
the measurement map comprises an inverse gate and a final measurement; and
the gate set does not form a group.

7. The method of claim 2, wherein:
the (epsilon, delta, gamma)-good URB scheme is under the Frobenius norm and a twirling map for the quantum system is a gamma-approximate twirl for gamma less than a function of delta and the dimension d.

8. The method of claim 1, further comprising:
selecting a gauge transformation; and
wherein the measurement map, implementation map, probability distribution, gauge transformation, and initial state are selected such that the gate set, measurement map, implementation map, probability distribution, gauge transformation, and initial state forms an (epsilon, delta, kappa, gamma)-good URB scheme for the quantum system under the diamond norm or trace norm.

9. The method of claim 1, wherein:
the implementation map for the selected gate set is selected to satisfy a gate-dependent replacement error model condition, a gate-independent replacement error model condition, or a unitary 2-design with a gate-independent error condition.

10. The method of claim 9, wherein:
the quality factor is the average fidelity of the gate set.

11. A system, comprising:
at least one processor; and
at least one non-transitory memory containing instructions that, when executed by the at least one processor, cause the system to perform operations for benchmarking a quantum system of dimension d, the operations comprising:
receiving a gate set and indications of a measurement map, an implementation map, a probability distribution, and an initial state based on the gate set;
estimating a first success probability for a sequence length m, estimation including:
choosing m random elements of the gate set according to the probability distribution,
sequentially apply, to the initial state on the quantum system and according to the implementation map, the implementation of each chosen random element, and
obtain a binary result by perform a measurement according to the measurement map on the final state; and
providing a quality factor based on estimated success probabilities for differing sequence lengths, the estimated success probabilities including the first success probability.

12. The system of claim 11, wherein:
the measurement map, implementation map, probability distribution, and initial state are selected such that the gate set, measurement map, implementation map, probability distribution, and initial state forms an (epsilon, delta, gamma)-good URB scheme for the quantum system.

13. The system of claim 12, wherein:
a twirling map for the quantum system is a gamma-approximate twirl for gamma less than a function of delta.

14. The system of claim 12, wherein:
wherein the quality factor is a base of an exponential curve fitted to the estimated success probabilities for the differing sequence lengths.

15. The system of claim 12, wherein:
the probability distribution is non-uniform and the gate set forms a group.

16. The system of claim 12, wherein:
the measurement map comprises an inverse gate and a final measurement; and
the gate set does not form a group.

17. The system of claim 12, wherein:
the (epsilon, delta, gamma)-good URB scheme is under the Frobenius norm and a twirling map for the quantum system is a gamma-approximate twirl for gamma less than a function of delta and the dimension d.

18. The system of claim 11, further comprising
selecting a gauge transformation; and
wherein the measurement map, implementation map, probability distribution, gauge transformation, and initial state are selected such that the gate set, measurement map, implementation map, probability distribution, gauge transformation, and initial state forms an (epsilon, delta, kappa, gamma)-good URB scheme for the quantum system under the diamond norm or trace norm.

19. The system of claim 11, wherein:
the implementation map for the selected gate set is selected to satisfy a gate-dependent replacement error model condition, a gate-independent replacement error model condition, or a unitary 2-design with a gate-independent error condition.

20. The system of claim 19, wherein:
the quality factor is the average fidelity of the gate set.
